(19) United States
(12) Patent Application Publication
(10) Pub. No.: US 2009/0317663 A1
(43) Pub. Date: Dec. 24, 2009

(54) MAGNETIC RECORDING MEDIUM

(75) Inventors: Sok-hyun KONG, Seoul (KR); Hyung-ik LEE, Suwon-si (KR); Hoo-san LEE, Osan-si (KR); Young-su CHUNG, Suwon-si (KR); Seong-yong YOON, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/485,093

(22) Filed: Jun. 16, 2009

(30) Foreign Application Priority Data
Jun. 23, 2008 (KR) 10-2008-0059604

(51) Int. Cl. G11B 5/725; G11B 5/72

(52) U.S. Cl. 428/833.3; 428/833.2

(57) ABSTRACT

Provided is a magnetic recording medium. The magnetic recording medium includes a substrate, a recording layer disposed on the substrate for magnetic recording, and a carbon protection layer, which includes a carbon layer and a blocking layer disposed in the carbon layer to block infiltration of external impurities, disposed on the recording layer. Since the blocking layer is disposed in the carbon layer, a thickness of the carbon protection layer can be reduced while a sufficient hardness to protect the recording layer can be ensured, and moreover, a softness of the surface of the carbon protection layer can be improved.

### CROSS-REFERENCE TO RELATED APPLICATIONS

This application claims the benefit of Korean Patent Application No. 10-2008-0059604, filed on Jun. 23, 2008, in the Korean Intellectual Property Office, the disclosure of which is incorporated herein in its entirety by reference.

### BACKGROUND

1. Field of the General Inventive Concept

One or more embodiments relate to a magnetic recording medium, and more particularly, to a magnetic recording medium including a carbon protection layer.

2. Description of the Related Art

Recently, information recording devices that can record/reproduce data in high density have been required due to a rapid increase in the distribution of information. In particular, hard disk drives using a magnetic recording medium are highlighted as information recording media in various digital devices, as well as in computers, due to characteristics such as a large storage capacity and rapid data recovery.

In a hard disk drive, a head floats above a magnetic recording medium, which rotates at a high speed of thousands of rpm. The head records information in the magnetic recording medium by applying a magnetic field onto a recording layer of the magnetic recording medium and alternatively, reproduces the information by detecting magnetic tray fields emitted from the recording layer. In order to increase the recording density, a distance between the head and the recording layer should be reduced so that a strong magnetic head field can be applied onto the recording layer having high coercivity in the recording operation. In addition, in order to improve a reproducing efficiency of the magnetic recording medium, on which the information is recorded at a high density, the distance between the head and the recording layer should be further reduced so that a very weak magnetic stray field that is emitted from recording bits of the recording layer can be detected. The distance between the head and the recording layer includes an air space, which is a distance between the head and the magnetic recording medium. The distance between the head and the recording layer is also governed by a thickness of a protective layer, which is located on an upper portion of the recording layer in the magnetic recording medium. Therefore, in order to maximize the recording and reproducing efficiency of the hard disk drive, the air space should be reduced, and the thickness of the protective layer of the magnetic recording medium should be reduced.

### SUMMARY

One or more embodiments of the present general inventive concept include a magnetic recording medium including a carbon protection layer that can ensure stability with a reduced thickness. In addition, a protective layer of the magnetic recording medium generally includes a carbon protection layer and a lubricant layer to protect a surface of the magnetic recording medium and stabilizing a flying status of a head.

Additional aspects and utilities of the present general inventive concept will be set forth in part in the description which follows and, in part, will be obvious from the description, or may be learned by practice of the present general inventive concept.

Embodiments of the present general inventive concept may be achieved by providing a magnetic recording medium including a substrate, a recording layer disposed on the substrate to provide magnetic recording, and a carbon protection layer, which includes a carbon layer and a blocking layer disposed in the carbon layer to block infiltration of external impurities, disposed on the recording layer.

The blocking layer may be formed as a thin film to separate the carbon layer into an upper carbon layer and a lower carbon layer. The blocking layer may include a plurality of islands that are locally coagulated on a plane located at a predetermined height in the carbon layer. The upper and lower carbon layers may be mono-like layers that are all formed under the same process conditions. The upper and lower carbon layers may be formed using a chemical vapor deposition (CVD) process or a sputtering process.

The carbon layer may include a first carbon layer located under the blocking layer and a second carbon layer located on the blocking layer. A concentration of hydrogen in the first carbon layer located under the blocking layer may be lower than a concentration of hydrogen in the second carbon layer located on the blocking layer. The second carbon layer on the blocking layer may be formed to a thickness of 0.1 nm to 4.0 nm. The first carbon layer under the blocking layer may be formed to a thickness of 1.0 nm to 4.0 nm.

The blocking layer may be formed to a thickness of 0.1 nm to 1.0 nm.

The blocking layer may be formed of a refractory metal. The blocking layer may be formed of at least one metal material selected from the group consisting of Ta, Ti, Zr, Hf, Mo, W, Cr, and Pt. Additionally, there may be a lubricant layer formed on the carbon protection layer.

Embodiments of the present general inventive concept may also be achieved by providing a recording layer to magnetically record data, and a carbon protection layer to protect the recording layer, the carbon protection layer including a blocking layer disposed therein at a predetermined depth to block hydrogen. The blocking layer may be formed by depositing refractory metal within the carbon protection layer.

The carbon protection layer may include a first carbon layer located under the blocking layer, and a second carbon layer located over the blocking layer. The blocking layer may block hydrogen in the first carbon layer to a hydrogen concentration of 20 atomic % or less. The blocking layer may block hydrogen in the first carbon layer to a hydrogen concentration of 10 atomic % or less. Portions of the first carbon layer and the second carbon layer may contact each other. The first carbon layer and the second carbon layer do not contact each other.

Embodiments of the present general inventive concept may also be achieved by providing a method of manufacturing a magnetic recording medium, including forming a recording layer on a substrate, forming a carbon layer over the recording layer, and depositing a blocking layer on the carbon layer, wherein the blocking layer is configured to block infiltration of external impurities. The blocking layer may be locally coagulated on a surface of the carbon layer to form a plurality of islands.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a cross-sectional view illustrating a magnetic recording medium of the present general inventive concept;

FIG. 2 is a cross-sectional view illustrating a magnetic recording medium according to another embodiment of the present general inventive concept;

FIG. 3 is a cross-sectional view illustrating a magnetic recording medium, in which a blocking layer is not disposed on a carbon layer according to another embodiment of the present general inventive concept;

FIG. 4 is a cross-sectional view illustrating a magnetic recording medium, in which a blocking layer is disposed on a carbon layer according to another embodiment of the present general inventive concept;

FIG. 5 is a graph illustrating a hydrogen concentration in the carbon layer according to whether the blocking layer is formed or not according to another embodiment of the present general inventive concept; and

FIG. 6 is a graph illustrating a hydrogen concentration in the carbon layer according to the thickness of the blocking layer according to another embodiment of the present general inventive concept.

### DETAILED DESCRIPTION OF THE EMBODIMENTS

Reference will now be made in detail to embodiments, examples of which are illustrated in the accompanying drawings, wherein like reference numerals refer to the like elements throughout. In this regard, the present embodiments may have different forms and should not be construed as being limited to the descriptions set forth herein. Accordingly, the embodiments are merely described below, by referring to the figures, to explain aspects of the present description.

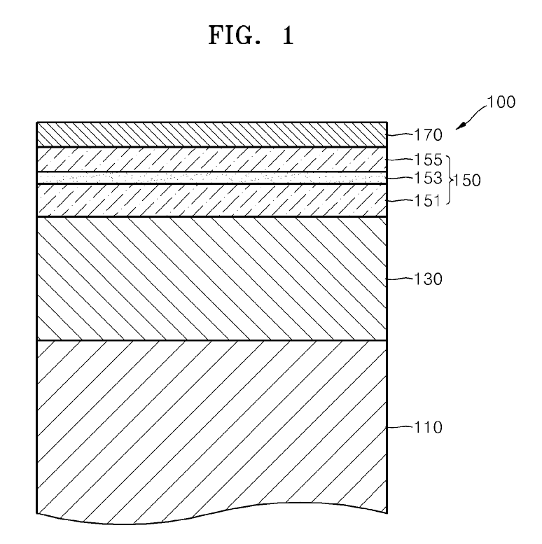

FIG. 1 is a cross-sectional view of a magnetic recording medium 100 according to an embodiment.

Referring to FIG. 1, the magnetic recording medium 100 includes a substrate 110, a recording layer 130, a carbon protection layer 150, and a lubricant layer 170 that are sequentially stacked.

The substrate 110 can be formed of any material that can be used to form a substrate in a general perpendicular magnetic recording medium, for example, glass, MgO, AlMg, or Si. The substrate 110 can be formed as a disk shape.

The recording layer 130 is a layer to perform the magnetic recording operation, and can be formed to have a single-layered structure or a multi-layered structure. The recording layer 130 can be formed of any material that can be used to form the recording layer in the general magnetic recording medium, for example, a magnetic material including an FePt alloy, an oxide of FePt alloy, a CoPt alloy, an oxide of CoPt alloy, or other like materials as are known in the art.

The magnetic recording medium 100 of the present embodiment may be a perpendicular magnetic recording medium. In the perpendicular magnetic recording medium, a soft magnetic layer (not illustrated) that can form a perpendicular magnetic path on the recording layer 130 may be disposed. The soft magnetic layer can be disposed between the substrate 110 and the recording layer 130, and may have a single-layered structure or a multi-layered structure. The soft magnetic layer can be formed of any material that can be used in a general perpendicular magnetic recording medium, for example, a soft magnetic material having a Co-based amorphous structure or including Fe or Ni. In addition, an intermediate layer (not illustrated) that improves the crystal orientation and magnetic properties of the recording layer may be further formed under the recording layer 130. A material to form the intermediate layer can be appropriately selected according to the material and crystallization structure of the recording layer 130. For example, the intermediate layer can be formed as a single-layered structure or a multi-layered structure including Ru, a Ru alloy, a Ru oxide, MgO, or Ni. Also, a buffer layer (not illustrated) or a magnetic domain control layer (not illustrated) may be further formed as additional layers in the magnetic recording medium.

The carbon protection layer 150 protects the recording layer 130, and includes carbon layers 151 and 155 and a blocking layer 153 that is disposed between the carbon layers 151 and 155.

The carbon layers 151 and 155 can be formed of diamond-like carbon (DLC), and may be mono-like layers that are all deposited under the same process conditions. For example, the carbon layers 151 and 155 can be deposited using a chemical vapor deposition (CVD) process or a sputtering process.

The blocking layer 153 can be formed by depositing refractory metal. For example, the blocking layer 153 can be formed of the refractory metal having a corrosion-resistance property such as Ta, Ti, Zr, Hf, Mo, W, Cr, or Pt.

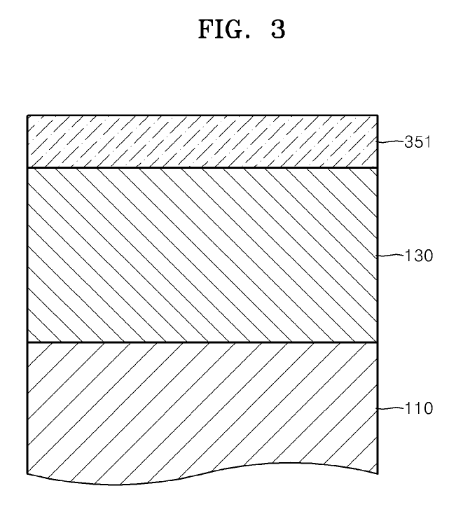

External impurity materials, for example, H2O, may be induced into the carbon layers 151 and 155 in the process of depositing the carbon layers 151 and 155, and thus, the blocking layer 153 may prevent the external impurities from being induced into the carbon layer 151, that is, the carbon layer 151 located under the blocking layer 153. As described above, since external impurity materials can be blocked, a concentration of hydrogen in the lower carbon layer 151 can be controlled to be much lower than that of the carbon layer 155, that is, the carbon layer 155 located on the blocking layer 153. On the other hand, since an additional blocking layer is not formed on the carbon layer 155, the concentration of hydrogen in the carbon layer 155 may be increased in the deposition process. For example, the content of hydrogen in the carbon layer 151 may be kept at about 10 atomic % or lower, and the content of hydrogen in the carbon layer 155 may be about 25 atomic %, as will be described with reference to FIGS. 3, 5 and 6. Relations between the blocking layer 153 and the hydrogen concentrations in the carbon layers 151 and 155 will be described with reference to FIGS. 3 through 6.

The blocking layer 153 can be formed to a thickness of a sub-nano meter, for example, a thickness of 0.1 nm to 1.0 nm. When the blocking layer 153 has a thickness of a sub-nano meter, the blocking layer 153 can block a lot of the external impurity materials induced into the lower carbon layer 151. Accordingly, even if the thickness of the lower carbon layer 151 is made smaller than that of conventional carbon layers, a sufficient hardness of the lower carbon layer 151 can be ensured. This is so because the hardness of the lower carbon layer 151 is increased by reducing the hydrogen concentration in the carbon layer 151. Even if the lower carbon layer 151 is formed to a thickness of a few nm, for example, 1.0 nm to 4.0 nm, the hardness requirement can be satisfied. The upper carbon layer 155, in which the hydrogen concentration is increased to improve the softness of the carbon layer 155, is a surface area of the carbon protection layer 150. The upper carbon layer 155 can be formed to a thickness of a few nm to a sub-nm, for example, 0.1 nm to 4 nm, and then, the softness requirement can be satisfied. As described above, since the blocking layer 153 is disposed in the carbon protection layer 150, the thickness of the carbon protection layer 150 can be much smaller than that of conventional carbon protection layers.

The lubricant layer 170 is formed of, for example, Tetraol lubricant, and reduces abrasions of a magnetic head (not illustrated) and the carbon protection layer 150, which are caused by the magnetic head colliding with the carbon protection layer 150 and sliding that occurs between the magnetic head and the carbon protection layer 150.

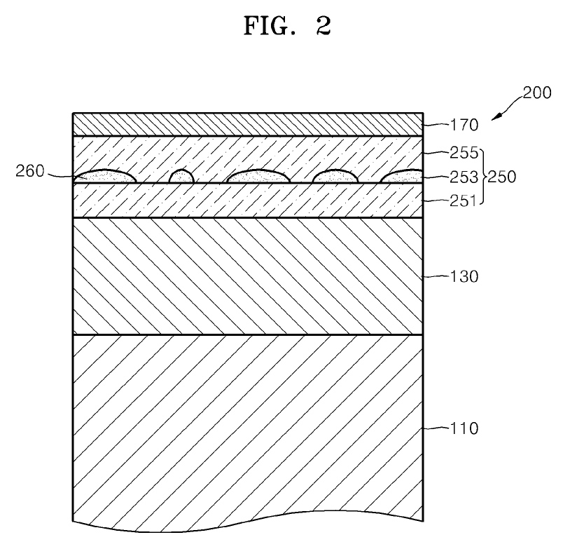

In FIG. 1, the blocking layer 153 is formed as a thin film that fully covers the upper portion of the lower carbon layer 151, and thus, the carbon layers 151 and 155 are clearly separated from each other. However, the one or more embodiments of the present general inventive concept are not limited to the above example. FIG. 2 illustrates a modified example of the magnetic recording medium 200, in which the blocking layer 253 includes a plurality of islands 260.

Referring to FIGS. 1 and 2, a magnetic recording medium 200 of the present modified example includes the substrate 110, the recording layer 130, a carbon protection layer 250, and the lubricant layer 170, which are sequentially stacked. The carbon protection layer 250 includes a lower carbon layer 251, an upper carbon layer 255, and a blocking layer 253 including a plurality of islands 260. Thus, as illustrated in FIG. 2, the lower carbon layer 251 and the upper carbon layer 255 are not totally separated from each other physically, and some portions of the lower and upper carbon layers 251 and 255 contact each other. Therefore, in the present general inventive concept including one or more embodiments, the lower carbon layers 151 and 251 and the upper carbon layers 155 and 255 may either be completely separated from each other by the blocking layer 153 as illustrated in FIG. 1, or the layers may be partially connected to each other through the blocking layer 253 which includes island-like regions 260.

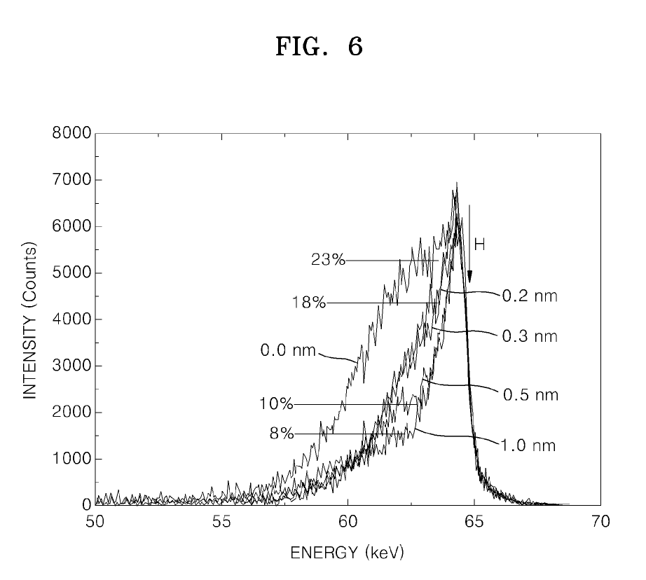

As illustrated in FIG. 2, a blocking layer 253 of Ta is deposited to a thickness of 0.1 nm to 0.3 nm, and the Ta metal can be locally coagulated on the surface of the lower carbon layer 251 to form an island 260. Even when the blocking layer 253 is formed to the reduced thickness of 0.1 nm to 0.3 nm, the hydrogen concentration in the lower carbon layer 251 can be controlled as will be further described in relation to FIG. 6. Even if the blocking layer 253 does not completely cover the upper portion of the lower carbon layer 251, the blocking layer 253 can control the hydrogen concentration in the lower carbon layer 251 because the blocking layer 253 can shield the lower carbon layer 251 against external impurity materials or gather the hydrogen (H-gathering).

Relations between the blocking layers 153 and 253, the lower carbon layers 151 and 251, and the upper carbon layers 155 and 255 will be described in more detail below.

It is well known that a residual compressive stress or a hardness of a carbon overcoat can be changed according to an inflow of hydrogen during deposition of the carbon overcoat. For example, a ratio of sp3 C—H bonding increases according to an increase in the hydrogen in the carbon overcoat, and thus, the residual compressive stress is reduced and the softness increases like a polymer. The upper surface of the carbon protection layer requires some degree of softness in order to improve a flying ability of the head. According to the conventional art, a carbon protection layer having a double-layered structure without a blocking layer, which includes the lower and upper carbon layers that are formed in different processing conditions from each other, is formed. For example, in the conventional double-layered carbon protection layer without a blocking layer, a hardness of the lower carbon layer is increased by increasing a ratio of sp3 bonding including C—C bonding in the lower carbon layer, and a ratio of bonding with the lubricant layer is controlled by inducing nitrogen in the upper carbon layer to form C—N functional groups. However, according to the present general inventive concept, the lower carbon layers 151 and 251, and upper carbon layers 155 and 255 are all deposited under the same process conditions to be formed as mono-like layers having similar crystallization structures to each other. In addition, the hydrogen that is naturally induced into the lower carbon layers 151 and 251 during the deposition process is controlled by using blocking layers 153 or 253 to prevent the hydrogen concentration from increasing in the lower carbon layers 151 or 251.

FIGS. 3 through 6 illustrate experimental data regarding the hydrogen concentration in the lower and upper carbon layers according to the existence of the blocking layer or the thickness of the blocking layer.

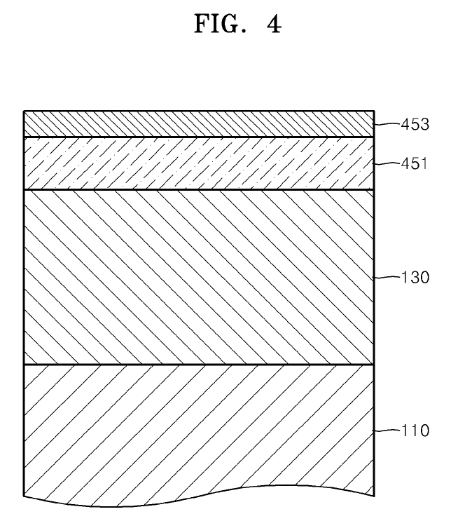

FIG. 3 illustrates an example of a portion of a magnetic recording medium, in which there is no blocking layer on a carbon layer 351, and FIG. 4 illustrates an example of the magnetic recording medium, in which a blocking layer 453 is formed on a carbon layer 451. The carbon layers 351 and 451 are deposited to a thickness of 3 nm, or 30 angstroms, using a CVD process.

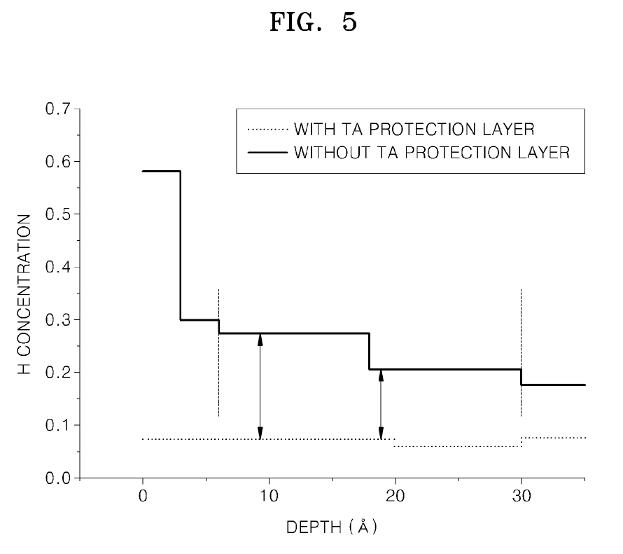

FIG. 5 is a graph illustrating a hydrogen concentration in the lower carbon layer according to whether the blocking layer is formed or not above the lower carbon layer. Referring to FIG. 5, the solid line denotes the case where the blocking layer is not formed on the carbon layer 351, as in the example illustrated in FIG. 3, and the dotted line denotes that case where the blocking layer is formed on the carbon layer 451, as in the example illustrated in FIG. 4. In the magnetic recording medium, in which the blocking layer is not formed on the carbon layer 351, the hydrogen content in the carbon layer 351 at a portion close to the surface of the carbon layer 351 is high, at about 0.3 hydrogen concentration, or 30 atomic % hydrogen in the carbon layer, and the hydrogen content is gradually reduced to about 0.2 hydrogen concentration, or 20 atomic % hydrogen in the carbon layer toward a boundary region between the carbon layer 351 and the recording layer 130. Therefore, the average hydrogen content in the carbon layer 351 is about 25 atomic % when there is no blocking layer present. The average hydrogen content of 25 atomic % corresponds to the hydrogen content in the conventional carbon protection layer. However, in the magnetic recording medium illustrated in FIG. 4, in which the blocking layer 453 is formed on the carbon layer 451, the hydrogen content is 0.1 hydrogen concentration, that is, 10 atomic % hydrogen or less throughout the entire region of the carbon layer 451. Significantly, the hydrogen contents in the carbon layers 351 and 451 may vary by up to about 20 atomic % depending on the existence of the blocking layer 453. According to the graph of FIG. 5, the hydrogen content can be controlled using the blocking layer 453. It can be understood that the hydrogen included in the carbon layer 351 or 451 is formed due to the infiltration of external impurity materials, for example, H2O, due to the distribution of the hydrogen content according to the depth of the carbon layer. Therefore, the blocking layers 153 and 253 disposed between the lower carbon layers and the upper carbon layers are advantageous in blocking unwanted hydrogen, and allowing the lower carbon layers 151 and 251 to be made thinner than related art devices yet retain desired hardness. The thinner lower carbon layers 151 and 251 also allow the carbon protections layers 150 and 250 illustrated in FIGS. 1 and 2 to be made thinner than in related art devices, thus shortening the distance between the recording layers 130 and 230 and the head. This shorter distance may allow an increase in the recoding density of a head of a hard disk drive, improve a reproducing efficiency of the magnetic recording medium, and allow detection of a weak magnetic stray field emitted from recording bits of the recording layer.

The magnetic recording medium 100 or 200 of the present general inventive concept presents a configuration that may block the infiltration of external impurity materials into the lower carbon layers 151 or 251 by using the blocking layer 153 or 253, and thus, the hydrogen content in the lower carbon layer 151 or 251 can be reduced. Therefore, the sufficient hardness of the lower carbon layer 151 or 251 can be maintained even if the thickness of the lower carbon layer 151 or 251 is reduced. In addition, since an additional blocking layer is not formed on the upper carbon layer 155 or 255, the hydrogen content in the upper carbon layer 155 or 255 naturally increases due to the infiltration of the external impurity materials, and then, the residual compressive stress can be reduced and the softness of the upper carbon layer can increase.

FIG. 6 is a graph showing the intensity and energy of recoiled hydrogen atoms, when the 500 keV nitrogen ions are irradiated into various carbon layers having a blocking layers. The thickness of the blocking layer may be 0.0 nm, 0.2 nm, 0.3 nm, 0.5 nm, or 1.0 nm. The experimental data was obtained by Elastic Recoil Detection Analysis (ERDA) apparatus. The experimental data shown in the graph of FIG. 6 illustrates experimental data regarding the hydrogen concentration in the carbon layer according to the thickness of the blocking layer. Referring to FIG. 6, when the thickness of the blocking layer is 0.0 nm, that is, when there is no blocking layer, the hydrogen concentration in the carbon layer is maintained at about 25 atomic %. On the other hand, when the thickness of the blocking layer is 0.5 nm or greater, the hydrogen concentration in the carbon layer greatly decreases. Even when the thickness of the blocking layer is about 0.2 nm to 0.3 nm, the increase in the hydrogen concentration can be restrained compared to the case where there is no blocking layer.

The data illustrated in the graphs of FIGS. 5 and 6 illustrates that with the use of the blocking layer, the hydrogen concentration in the carbon layer located under the blocking layer may be kept low, and the hydrogen concentration in the carbon layer above the blocking layer maintained at about 25 atomic %. Detailed values of the hydrogen concentration may vary depending on the thickness of each layer in the carbon protection layer or depending on the processing conditions.

Although a few embodiments of the present general inventive concept have been illustrated and described, it will be appreciated by those skilled in the art that changes may be made in these embodiments without departing from the principles and spirit of the general inventive concept, the scope of which is defined in the appended claims and their equivalents.

What is claimed is:

1. A magnetic recording medium comprising:
a substrate;
a recording layer disposed on the substrate to provide magnetic recording; and
a carbon protection layer, which includes a carbon layer and a blocking layer disposed in the carbon layer to block infiltration of external impurities, disposed on the recording layer.

2. The magnetic recording medium of claim 1, wherein the blocking layer is formed as a thin film to separate the carbon layer into an upper carbon layer and a lower carbon layer.

3. The magnetic recording medium of claim 1, wherein the blocking layer includes a plurality of islands that are locally coagulated on a plane located at a predetermined height in the carbon layer.

4. The magnetic recording medium of claim 1, comprising:
upper and lower carbon layers that are mono-like layers and that are all formed under the same process conditions.

5. The magnetic recording medium of claim 4, wherein the upper and lower carbon layers are formed using a chemical vapor deposition (CVD) process or a sputtering process.

6. The magnetic recording medium of claim 1, wherein the carbon layer comprises:
a first carbon layer located under the blocking layer; and
a second carbon layer located on the blocking layer.

7. The magnetic recording medium of claim 6, wherein a concentration of hydrogen in the first carbon layer located under the blocking layer is lower than a concentration of hydrogen in the second carbon layer located on the blocking layer.

8. The magnetic recording medium of claim 6, wherein the second carbon layer on the blocking layer is formed to a thickness of 0.1 nm to 4.0 nm.

9. The magnetic recording medium of claim 6, wherein the first carbon layer under the blocking layer is formed to a thickness of 1.0 nm to 4.0 nm.

10. The magnetic recording medium of claim 1, wherein the blocking layer is formed to a thickness of 0.1 nm to 1.0 nm.

11. The magnetic recording medium of claim 1, wherein the blocking layer is formed of a refractory metal.

12. The magnetic recording medium of claim 1, wherein the blocking layer is formed of at least one metal material selected from the group consisting of Ta, Ti, Zr, Hf, Mo, W, Cr, and Pt.

13. The magnetic recording medium of claim 1, further comprising:
a lubricant layer formed on the carbon protection layer.

14. A magnetic recording medium, comprising:
a recording layer to magnetically record data; and
a carbon protection layer to protect the recording layer, the carbon protection layer including a blocking layer disposed therein at a predetermined depth to block hydrogen.

15. The magnetic recording medium of claim 14, wherein the blocking layer is formed by depositing refractory metal within the carbon protection layer.

16. The magnetic recording medium of claim 14, wherein the carbon protection layer comprises:
a first carbon layer located under the blocking layer; and
a second carbon layer located over the blocking layer.

17. The magnetic recording medium of claim 16, wherein the blocking layer blocks hydrogen in the first carbon layer to a hydrogen concentration of 20 atomic % or less.

18. The magnetic recording medium of claim 16, wherein the blocking layer blocks hydrogen in the first carbon layer to a hydrogen concentration of 10 atomic % or less.

19. The magnetic recording medium of claim 16, wherein portions of the first carbon layer and the second carbon layer contact each other

20. The magnetic recording medium of claim 16, wherein the first carbon layer and the second carbon layer do not contact each other.
